(19) United States
(12) Patent Application Publication
(10) Pub. No.: US 2004/0008265 A1
(43) Pub. Date: Jan. 15, 2004

(54) Wireless spread spectrum video communications device

(75) Inventors: Michael Kenneth Pedigo, Zionsville, IN (US); Terry Andrew Melkey, Indianapolis, IN (US); Ronald Gary Pace, Naperville, IL (US)

Correspondence Address: Michael K. Pedigo, 9684 Autumn Way, Zionsville, IN, 46077, US

(73) Assignee: Q Wireless, L.L.C.

(21) Appl. No.: 10/194,580

(22) Filed: Jul. 13, 2002

(51) Int. Cl. H04N 7/04

(52) U.S. Cl. 348/211.2

(57) ABSTRACT

A direct sequence spread spectrum approach to wireless video transmissions is utilized. This approach provides a lowered spectral power density and also can provide scrambling of the video signal. By providing lower spectral power density the transmitter portion of the invention can operate at higher radio frequency output power levels while remaining in compliance with government regulation for unlicensed use. For example, in the United States, the Federal Communications Commission Part 15 rules allow for higher total conducted output power as long as the spectral power density is limited to +8 dBm for any 3 KHz bandwidth within the allocated band.

### CROSS REFERENCE TO RELATED APPLICATIONS

No related application is known.

### BACKGROUND OF THE INVENTION

The present invention provides a superior means to wirelessly transmit and receive video. A direct sequence spread spectrum approach is utilized to provide lower spectral power density and also provides encryption of the video signal. By providing lower spectral power density the transmitter portion of the invention can operate at higher radio frequency output power levels while remaining in compliance with government regulation for unlicensed use. For example, in the United States, the Federal Communications Commission (hereinafter FCC) Part 15 rules allow for higher total conducted output power as long as the spectral power density is limited to +8 dBm for any 3 KHz bandwidth within the allocated band.

In comparison, FCC Part 15 rules that regulate non-spread spectrum analog wireless video transmitters require the total conducted transmitter power output of one (1) to two (2) milliwatts, depending on the gain of the transmitting antenna. (For non-spread spectrum analog video transmitters the regulatory limitations is in field strength which convert to approximately the conducted power as mentioned herein). The transmitter in our invention is allowed up to 1 Watt when utilizing sufficient frequency spreading. The much greater transmitter power available from our invention provides for much longer communications range and a higher quality video and audio signal at any range shorter than the maximum communications range.

In addition, our invention provides a means for encrypting the video such that any unauthorized person cannot receive and then view the video. This encryption thus provides privacy. Our invention can provide a very robust, code based, encryption where any unauthorized viewer must first determine the sequence of the code before he/she can successfully view the transmitted video.

### BRIEF SUMMARY OF THE INVENTION

The present invention provides a means for spread spectrum communications of video. Normal video synchronization signals are shared for spread spectrum code synchronization thereby providing a very low cost approach.

### BRIEF DESCRIPTION OF THE DRAWINGS

FIG. 1 is a block diagram of the apparatus that illustrates important components of the apparatus.

FIG. 2 is a block diagram of the transmitter part of the apparatus.

FIG. 3 is a block diagram of the receiver part of the apparatus.

FIG. 4 is a schematic diagram of spread spectrum specific circuits which are utilized in both the transmitter part and receiver part of the apparatus.

FIG. 5 is a schematic diagram of the transmitter part of the apparatus for circuits other than those shown in FIG. 4.

FIG. 6 (shown as sections FIG. 6A and 6B) is a schematic diagram of the receiver part of the apparatus for circuits other than those shown in FIG. 4.

### DETAILED DESCRIPTION OF THE PREFERRED EMBODIMENT

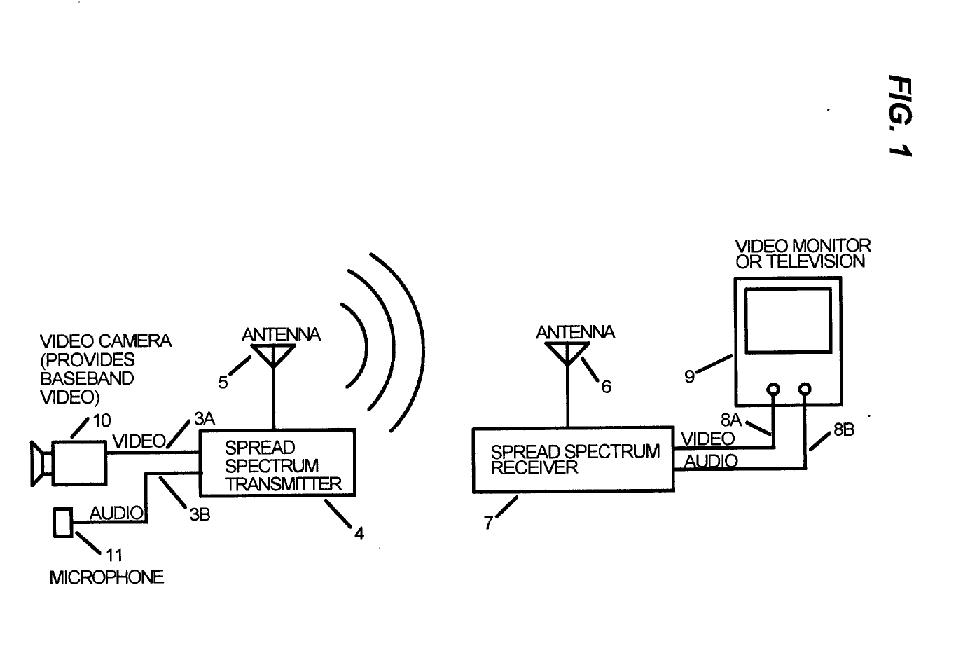

Please refer to the apparatus shown in FIG. 1. A video camera (10) with video (3A) output and a microphone (11) with audio (3B) output are connected to a spread spectrum transmitter (4). The spread spectrum transmitter has a radio frequency output radiating from the transmitting antenna (5). A fraction of the radiated radio frequency energy from the transmitting antenna (5) is received by the receiving antenna (6). The receiving antenna (6) is connected to the spread spectrum receiver (7). The spread spectrum receiver has a received video output (8A) and a received audio output (8B), these outputs (8A and 8B) then connect to a video monitor or television (9). The signals available on the received video output (8A) and received audio output (8B) are a reconstruction of the original video (3A) and audio (3B) signals from the video camera (2).

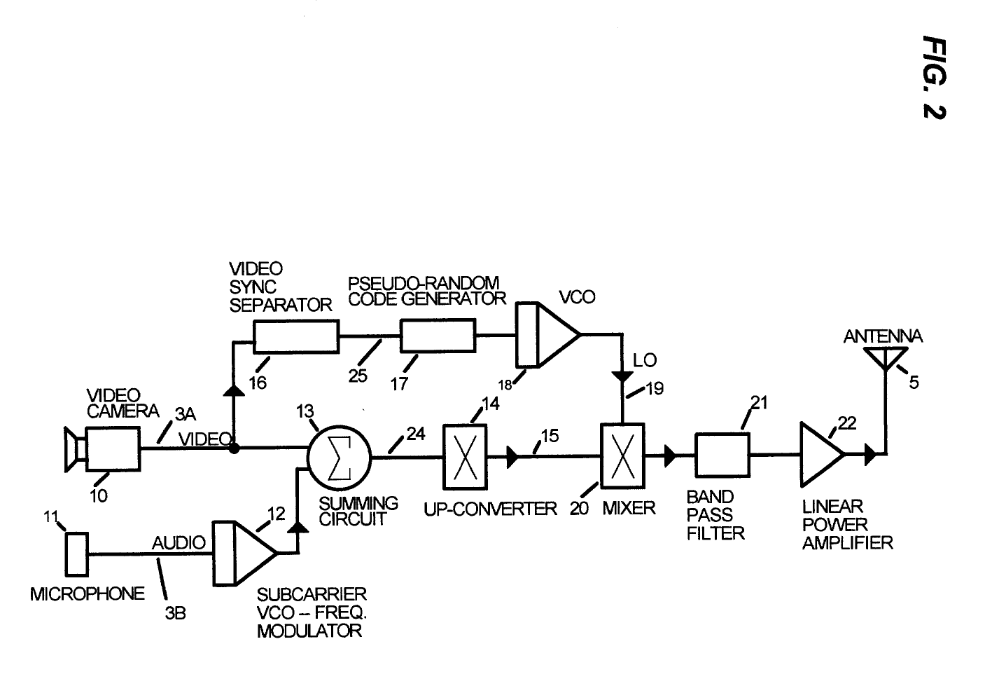

Now referring to both FIG. 1 and FIG. 2, an important feature of the spread spectrum transmitter (4) is that it has a pseudo-random code generator (17) and its output pseudo-random code sequence is synchronized with the video vertical sync signal that is part of the video signal on the video output (3A) of the video camera (2). Furthermore, this synchronization of the pseudo random code generator (17) with the video vertical sync signal is accomplished in the spread spectrum transmitter (4). In addition, within the spread spectrum transmitter (4) are means to create a radio frequency carrier and a means to modulate said radio frequency carrier.

FIG. 2 shows that the audio (3B) is applied to a subcarrier VCO (12) which results in the subcarrier being frequency modulated with the audio (3B). [For the preferred embodiment the unmodulated subcarrier frequency of the output of the subcarrier VCO (12) is approximately 4.5 MHz with peak frequency modulation of this subcarrier being plus and minus 25 KHz. However, any other subcarrier frequency or modulation level may be chosen.] Said subcarrier being frequency modulated with the audio is then summed [using summing circuit (13)] with the video (3A) signal to produce a composite video signal (24). Said composite video signal (24) is connected to an up-converter (14) which up-converts the frequency of the baseband composite video signal (24). For the preferred embodiment the up-converter output (15) is a frequency translation of the baseband composite video signal (24) by 61.25 MHz. However, any other frequency translation may be chosen.

Referring again to the video output (3A) of the video camera (10), said video output (3A) connects to a video sync separator (16). The video sync separator (16) generates a time accurate video vertical sync output (25) which is utilized to initialize the pseudo-random code generator (17). Thus, the pseudo-random code sequence is synchronized to the vertical sync of the video signal (3A).

For the preferred embodiment the pseudo-random code is a linearly maximal ten bit code which repeats every 1023 bits and is a serial code with a 300 Kbaud rate. However, any other pseudo-random code and code length can be utilized.

The output of the pseudo-random code generator (17) connects to the input of a VCO (18) and therefore frequency modulates said VCO carrier frequency output(19). For the preferred embodiment said VCO (18) has a carrier of approximately 976.25 MEz and the pseudo-random code modulates said carrier with a frequency modulation of approximately plus and minus 300 KHz. However, any other carrier frequency and level of frequency modulation can be used.

The output of said VCO (19) is then mixed [via mixer (20)] with the output of the up-converter (15). For the preferred embodiment the mixer (20) produces a difference frequency which is centered at 915.0 MHz which is then filtered by the band pass filter (21) to remove or reduce undesired mixing products. However, the mixer output may be centered on any desired frequency and the band pass filter (21) can select either the sum or difference frequency output of the mixer (20).

The output of the band pass filter (21) connects to the input of a linear power amplifier (22). The output of said linear power amplifier then drives the transmitter antenna (5).

The signal at the transmitter antenna (5) has a spectral plot wherein the spectral power density (i.e.—milliwatts per kilohertz) is reduced by the pseudo-random code modulation. This reduces the jamming potential of the transmitter's output on other devices operating in the same band. For the preferred embodiment, as described herein, the composite video causes effectively an amplitude modulation of a 915.0 MHz carrier and the pseudo-random code generator causes a frequency modulation of the same 915.0 MHz carrier. However, the composite video and pseudo-random code can cause any type modulation of the carrier—amplitude modulation, frequency modulation, or phase modulation. The composite video and pseudo-random code can cause different type of modulations, for example, one being amplitude modulation and the other being frequency modulation; or the composite video and pseudo-random code can cause the same type of modulation, for example both being frequency modulation.

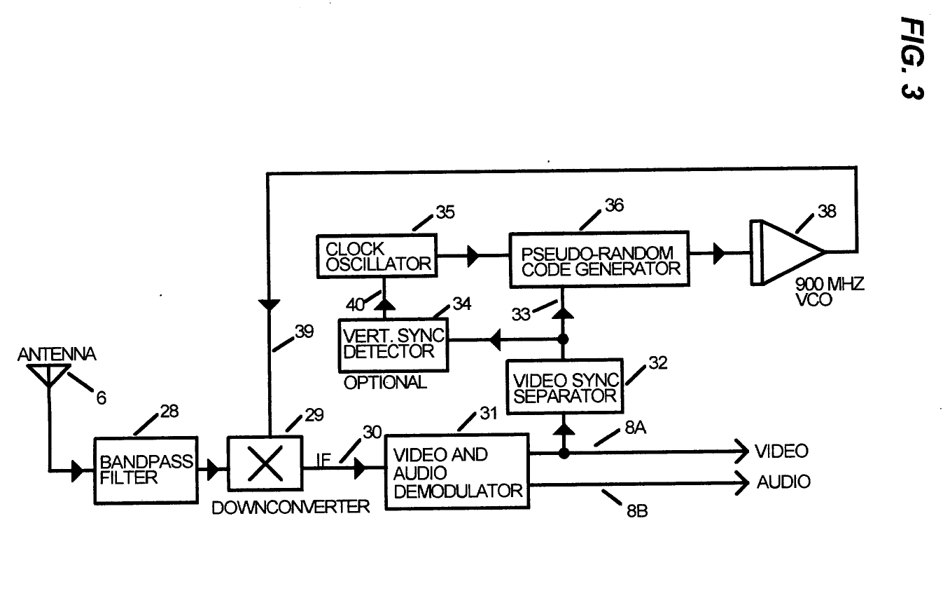

Now refer to FIG. 3 which is a block diagram showing the receiver. Part of the radio frequency energy radiating from the transmitter antenna (5) is captured by the receiver antenna (6). The captured signal is then filtered by a bandpass filter (28) which reduces off-channel undesired signals. The output of the bandpass filter (28) connects to a downconverter (29). In the preferred embodiment, this downconverter (29) is a combination of a low noise amplifier (LNA) followed by a downconverting mixer which provides a frequency offset from the original captured radio frequency signal to a lower intermediate frequency (IF). This reduction in frequency brings the desired signal within the frequency range required to be capable of demodulating the desired video and audio signals. In this regard, the output of said downconverter (29) is connected to the input of a video and audio demodulator (31) which then demodulates the intermediate frequency signal (30) and provides a baseband video (8A) and audio (8B) output.

The recovered baseband video (8A) signal is connected to a video sync separator (32) which has a vertical sync output (33). Said vertical sync output (33) is utilized to reset a pseudo-random code generator (36) - hereinafter referred to as the receiver pseudo-random code generator. Said receiver pseudo-random code generator (36) provides the same code sequence as the transmitter pseudo-random code generator (17) which is shown in FIG. 2. As previously described herein the transmitter pseudo-random code generator (17) sequence is initialized by the vertical sync pulse within the original video camera (10) video output. Now, since the sequence of the receiver pseudo-random code generator (36) is likewise initialized with the vertical sync signal in the receivers recovered baseband video signal (8A) the receiver pseudo-random code generator (36) then becomes synchronized with transmitter pseudo-random code generator (17). This is the result since the received baseband video signal (8A) is an accurate reconstruction of the video camera's (10) video output (3A).

It is important to mention that for the transmitter and receiver pseudo-random codes to remain synchronized that the transmitter pseudo-random code generator (17) and the receiver pseudo-random code generator (36) should be clocked with clock oscillators that provide the same clock frequency plus or minus some unavoidable small error frequency—said error frequency being a result of the tolerances of said clock oscillators.

Nonetheless, for both the transmitter and receiver pseudo-random code generators to synchronize together the receiver video sync separator (32) must be able to recover the video vertical sync pulse (33). If the modulation level caused by the transmitter pseudo-random code is below a level that causes corruption of the receiver video sync separator (32) then the receiver pseudo-random code generator (36) will immediately become synchronized whenever a valid vertical sync pulse is received and detected. However, if the modulation level caused by the transmitter pseudo-random code is above that which causes corruption of the receiver video sync separator (32) then proper synchronization will not be achieved unless the sequence of both the transmitter and receiver pseudo-random code generators just happens to be within one bit of each other. However, since these codes are 1023 bits in length (for the preferred embodiment) this would be a rare occurrence. In this regard, for direct sequence spread spectrum systems, such as the preferred embodiment as described herein, whenever the sequence of the transmitter pseudo-random code is within one bit of sequence of the receiver pseudo-random code then the effects of the modulation due to the transmitter pseudo-random code is nulled or reduced—this effect generally called despreading.

One means to insure said despreading is to have the sequence between the transmitter and receiver pseudo-random codes clock at a slightly different frequency—this generally being referred to “sliding”. Then detect when the code sequences slide within one bit of each other and at that point in time remove said “sliding” and apply the same clock frequency to both the transmitter (17) and receiver (36) pseudo-random code generators. FIG. 3 shows an optional means to do said “sliding”. The output of the video sync separator (33) is connected to a vertical sync detector (34). With high modulation levels of the transmitter pseudo-random code there will not be a valid vertical sync at the output of the video sync separator (33) until the bit pattern for both the transmitter (17) and receiver (36) pseudo-random code generators slide on top of each other—in the time domain. Then whenever a valid vertical sync signal is recovered at the output of the video sync separator (32) the optional vertical sync detector (34) adjusts the receiver clock oscillator (35) to synchronize the receive pseudo-random code with the transmitter's pseudo-random code. This synchronization remaining valid as long as vertical sync pulses are recovered at the output of the receiver video sync separator (32).

For the preferred embodiment said “sliding” feature and the receiver vertical sync detector (34) are optional and only needed if the transmitter pseudo-random code modulation is set to be above the level that causes corruption of the receiver video sync separator (32) operation. Notwithstanding if the transmitter pseudo-random code modulation level is either less or more than that which corrupts the receiver vertical sync separator (32) it is important to remove the effects of the modulation resulting from the transmitter pseudo-random code since this modulation will reduce the quality of the recovered video (8A) and audio (8B). In the preferred embodiment, this is accomplished by “feedback” of equivalent modulation resulting from the receiver pseudo-random code generator (36) output to the local oscillator input (39) of the receiver downconvertor (29).

For the preferred embodiment, the transmitter pseudo-random code causes frequency modulation. For nulling or “despreading” the receiver pseudo-random code must cause the same frequency modulation of the downconverter (29) local oscillator input (39). This is accomplished by applying the output of the receiver pseudo-random code generator (36) to a VCO (38) thereby causing frequency modulation of the VCO (38) output (39). The VCO (38) output (39) is then utilized as the downconverter (29) local oscillator. With the same level of frequency modulation of the receiver VCO (38) as in the transmitter VCO (18) then effects of the transmitter modulation resulting from the transmitter pseudo-random code generator (17) is nulled and removed.

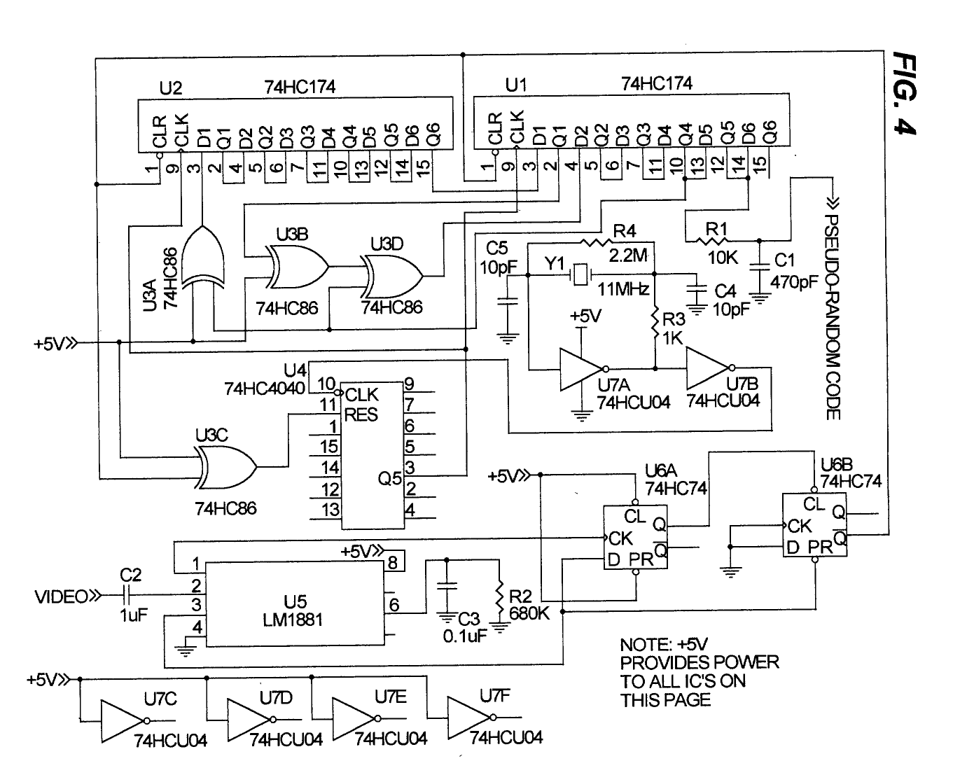

FIG. 4 is a schematic representation of the circuits that provide a pseudo-random code generator, video sync separator, and clock oscillator which for the preferred embodiment is utilized in both the transmitter and receiver. The items labeled U1, U2, U3A, U3B, and U3D provide a 1023 bit sequential pseudo-random code generator. Items U5, U6A, U6B, C2, C3, and R2 provide the video sync separator function with vertical sync output, and items U3C, U4, U7A, U7B, Y1, C4, C5, R3, and R4 provide the clock oscillator function. Items U7C, U7D, U7E, and U7F are unused sections of components that are partially used in the circuit.

The vertical sync output of the video sync separator is pin 8 of U6B which is a short, temporally accurate, video vertical sync pulse which initializes the pseudo-random code generator. Item U4 (a divide by 32 counter) insures that initialization happens within one thirty-second (1/32) of a bit time of the pseudo-random sequence. Therefore, the first bit in the pseudo-random code sequence, immediately after initialization, will have nearly a full bit time duration and the time accuracy of the synchronization, to the video vertical sync, will be one-thirty second (1/32) of time duration of a pseudo random code generator bit - even though the video vertical sync pulse is asynchronous with the pseudo-random code generator clock oscillator.

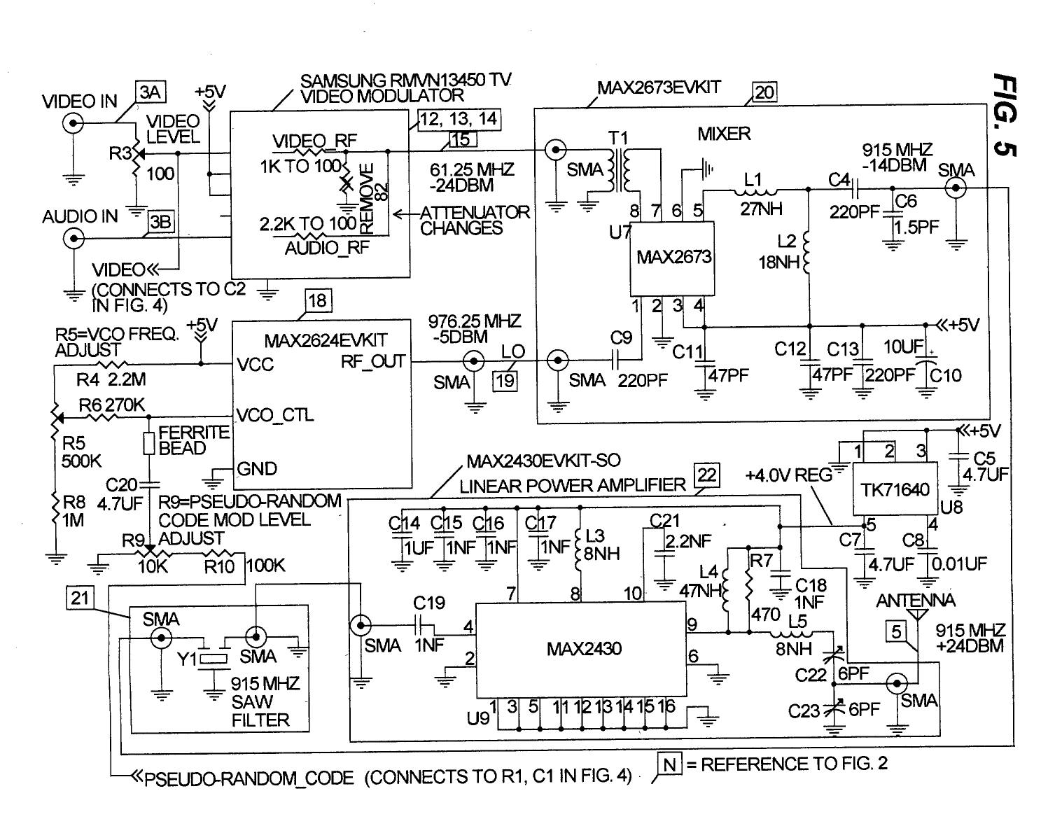

FIG. 5 shows an embodiment of the other circuits, beyond those in FIG. 4, to produce a complete transmitter. In FIG. 5 the numbers encased in rectangular boxes show the corresponding circuits to the connections and blocks of FIG. 2. The video input (3A) connects to a potentiometer (R3) which provides an adjustment of the video level necessary to be within the dynamic range of the Samsung RMVN13450 TV Video Modulator (hereinafter “Samsung modulator”)—said Samsung modulator providing the function of items 12, 13, and 14 of FIG. 2. Also, the wiper of R3 also connects to C2 of FIG. 4—the video input of the video sync separator (item 16 of FIG. 2). The output of said Samsung modulator is connected to the Maxim MAX2673EVKIT mixer which provides function of item 20 of FIG. 2. Also connected to the Maxim MAX2673EVKIT is the Maxim MAX2624EVKIT which furnishes a voltage controlled oscillator (VCO) to provide the function of item 18 of FIG. 2 and supplies the local oscillator (hereinafter “LO”—function of item 19 of FIG. 2). The output of the pseudo-random code generator (item 17 of FIG. 2 and actual connection to junction of R1 and C1 of FIG. 4) connects to the MAX2624EVKIT through network of R9, R10, and C20—these two resistors and capacitor providing modulation level adjustment and DC blocking respectively. Thus the output of the MAX2624EVKIT (RF_out on FIG. 5) becomes a frequency modulated carrier with modulation caused by the pseudo-random code-generator.

The MAX2673EVKIT provides a sum and difference frequency between the output of said Samsung modulator and the said LO. In the preferred embodiment the output of said Samsung modulator is a signal centered on 61.25 MHz and said LO is centered on 976.25 MHz but other frequencies can be utilized for both said Samsung modulator output and said LO. Therefore, for the preferred embodiment, the sum component is 1037.5 MHz and the difference component is 915.0 MHz. To attenuate the sum component and to select the difference component centered at 915.0 MHz the output of the MAX2673EVKIT is connected to a 915 MHz SAW filter which is a bandpass filter that has a center frequency of 915.0 MHz and at least a ±6 MHz pass bandwidth. The output of the bandpass filter then connects to the RF input of the MAX2430EVKIT-SO which is a linear power amplifier that provides up to +24 dBm of radio frequency output power.

Generally, the circuits in both FIG. 4 and FIG. 5 operate on a regulated +5V DC power supply. However, the MAX2430EVKIT-SO linear power amplifier requires a lower voltage. FIG. 5 shows components U8, C5, C7, and C8 which supply a +4V DC power supply for the MAX2430EVKIT-SO.

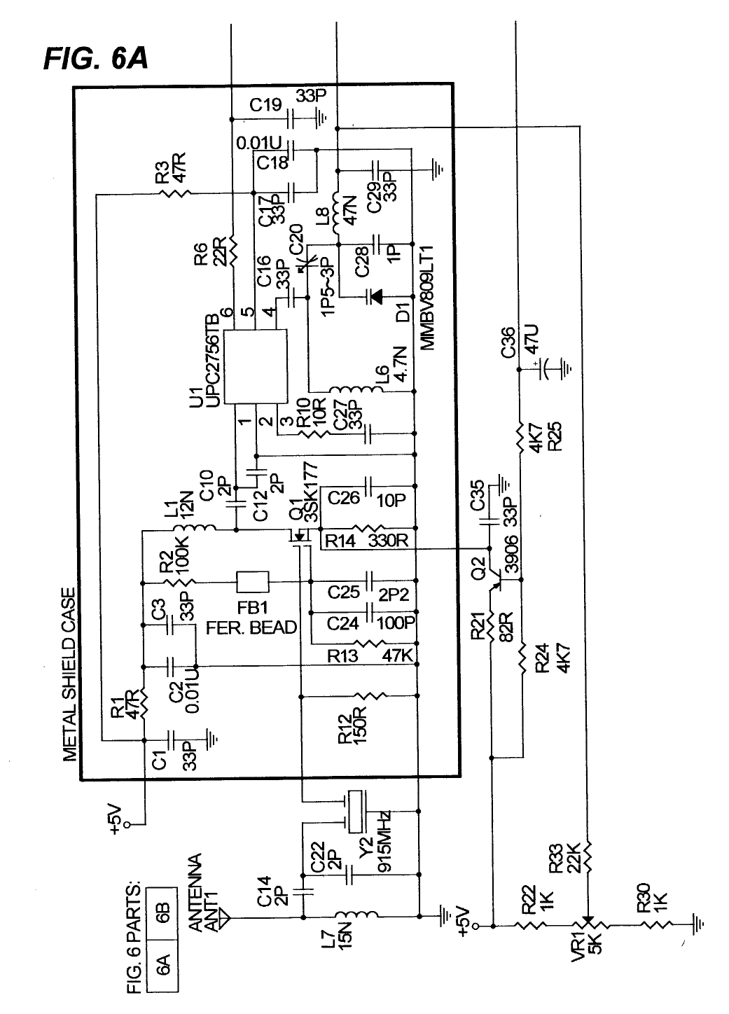

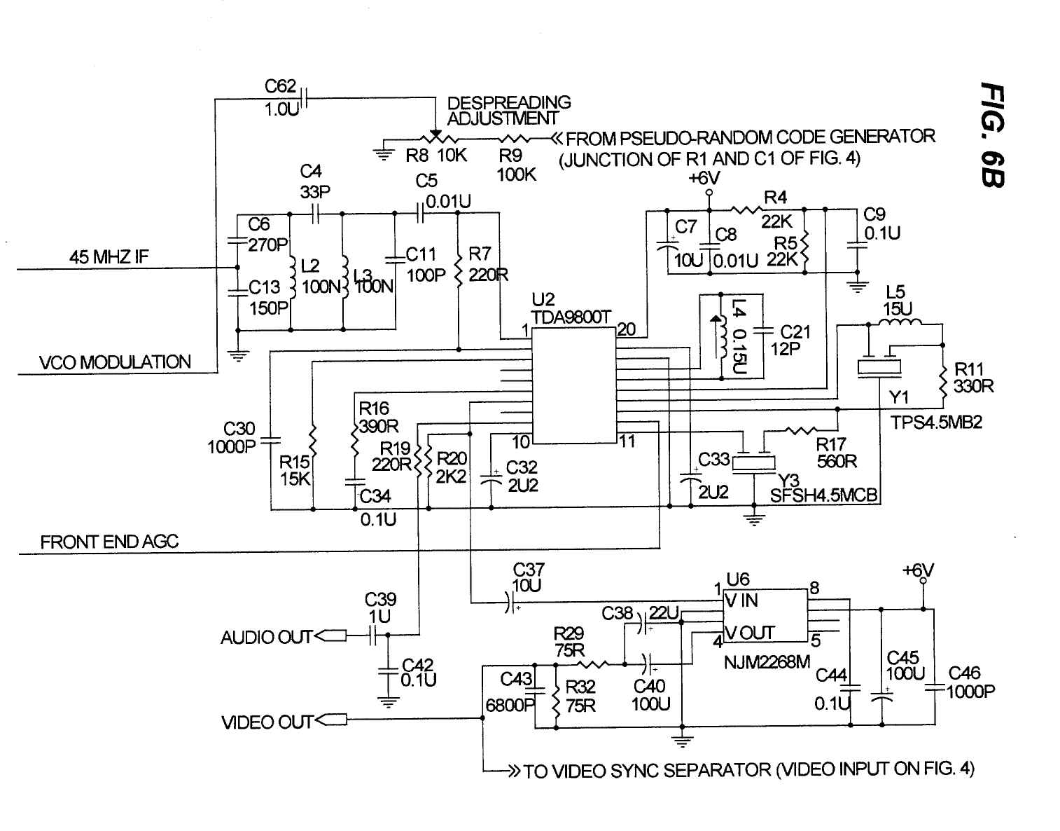

Referring now to the receiver, FIG. 6 is a schematic that shows the components and circuits that are added to the components and circuits in FIG. 4 to produce a receiver. Referring to FIG. 6, from the antenna (ANTI) the components L7, C14, and C22 provide an impedance match between the antenna and 915 MHz bandpass filter (Y2). This antenna match is optimum for a one-half wave monopole antenna. The output of the 915 MHz bandpass filter connects to a low noise amplifier (hereinafter, “LNA”) which is composed of components: Q1, C1, C2, C3, C10, C12, C24, C25, C26, L1, R1, R2, R12, R13, R14, and FB1 (a ferrite bead). The output of said LNA (drain of MOSFET Q1) is connected to the RF input of a combination mixer and VCO. This combination mixer and VCO is composed of the following components: U1, C16, C17, C18, C19, C20, C27, C28, C29, D1 (varactor diode), L6, L8 R3, R6, and R10. Said LNA and the combination mixer and VCO provide the functions of items 29 (downconverter) and 38 (900 MHz VCO) of FIG. 3.

The output of the downconverter (unction of R6 and C19) is the receiver intermediate frequency (IF, same as item 30 on FIG. 3) which then connects to the input of a “video and audio demodulator.” The “video and audio demodulator” is composed of the following components: U2, U6, C4, C5, C6, C7, C8, C9, C11, C13, C21, C30, C32, C33, C34, C37, C38, C39, C40, C42, C43, C44, C45, C46, L2, L3, L4, L5, R4, R5, R7, R11, 15, R16, R19, R20, R29, R32, Y1, and Y3. The components C4, C5, C6, C11, C13, L2, L3, and R7 provide the function of a 45 MHz bandpass filter within the “video and audio demodulator”. Furthermore integrated circuit U2 (TDA9800T from Philips Semiconductor) and its associated components provide the actual demodulation of the video and audio, and the integrated circuit U6 (NJM2268M from NJR Corporation) and its directly associated components act as a low impedance buffer amplifier to provide the capability of driving a 75 ohm cable.

The components C62, R8, and R9 interface between the output of the pseudo-random code generator (item 36 on FIG. 3, as well as junction of C1 and R1 on FIG. 4). The potentiometer R8 adjusts the modulation level of the receiver 900 MHz VCO. With the modulation levels of the transmitter VCO and receiver VCO being equivalent the effects of the pseudo-random code generators are effectively nulled and removed at the IF output of the downconverter (unction of C19 and R6 of FIG. 6).

Continuing to refer to FIG. 6, the components labeled C35, C36, R21, R24, R25, and Q2 provide a front end AGC amplifier which allows the reception of a strong signal from the transmitter without causing saturation. A strong transmitter signal would be received when the transmitter is close to the receiver. The components R22, R30, R33, and VR1 provide for adjustment of the receiver 900 MHz VCO carrier frequency.

All the receiver circuits are either powered by a regulated +5V DC supply and a regulated +6V DC supply.

We claim:

1. A wireless spread spectrum video communications apparatus that comprises:
a transmitter,
and one or a plurality of receivers;
said transmitter includes a video input means, a pseudo-random code generator means,
and a radio frequency transmitter means,
a video signal on said video input means and the output of said pseudo-random code generator means causing modulation of said radio frequency transmitter means;
the modulation of said radio frequency transmitter means by said pseudo-random generator means provides spectral spreading of the output of the radio frequency transmitter means to reduce the power per bandwidth spectral density;
said one or more receivers capable of receiving radio frequency transmissions from said transmitter;
and said one or a plurality of receivers capable of each providing a video output signal,
either baseband or modulating a carrier frequency, that is not tangibly degraded by the modulation resulting from said pseudo-random code generator on said radio frequency transmitter means.

2. The invention in claim 1 wherein said one or a plurality of receivers include a pseudo-random code generator means with a synchronization means to synchronize to the sequence of the pseudo-random code transmitted by said transmitter and received by said receiver.

3. The invention in claim 1 wherein said transmitter includes means to synchronize its pseudo-random code generator sequence to a sync signal contained within video signal.

4. The invention in claim 1 wherein:
said transmitter includes synchronization means to synchronize its pseudo-random code generator sequence to a sync signal contained within said video signal that is causing modulation of said radio frequency transmitter means,
said one or a plurality of receivers include a pseudo-random code generator means with a synchronization means to synchronize to a sync signal contained within a video signal transmitter by said transmitter and received by said one or a plurality of receivers.

5. The invention in claim 1 wherein:
said transmitter includes synchronization means to synchronize its pseudo-random code generator sequence to a sync signal contained within said video signal that is causing modulation of said radio frequency transmitter means,
said one or a plurality of receivers include a pseudo-random code generator means with a synchronization means to synchronize to a sync signal contained within a video signal transmitter by said transmitter and received by said one or a plurality of receivers,
and said modulation on said radio frequency transmitter caused by said pseudo-random code generator provides scrambling wherein the reception and demodulation of the output of said radio frequency transmitter by a separate video receiver, that is not part of this invention claimed herein, is tangibly degraded.

6. The invention in claim 1 wherein:
said transmitter includes synchronization means to synchronize its pseudo-random code generator sequence to a sync signal contained within said video signal that is causing modulation of said radio frequency transmitter means,
said one or a plurality of receivers include a pseudo-random code generator means with a synchronization means to synchronize to a sync signal contained within a video signal transmitter by said transmitter and received by said one or a plurality of receivers,
said video signal on said video input of said transmitter has both video and audio content,
and said modulation on said radio frequency transmitter caused by said pseudo-random code generator provides scrambling wherein the reception and demodulation of the video and audio content transmitted from said radio frequency transmitter by a separate video receiver that is not part of this invention claimed herein, is tangibly degraded.

7. The invention in claim 1 wherein the modulation resulting from the video signal on said video input means is either amplitude modulation, frequency modulation, or phase modulation.

8. The invention in claim 1 wherein the modulation resulting from the output of said pseudo-random code generator means is either amplitude modulation, frequency modulation, or phase modulation.

9. The invention in claim 1 wherein said video signal on said video input means includes video only content or both audio and video content.

10. The invention in claim 1 wherein said video signal on said video input means is either a NTSC, PAL, or SECAM composite video signal.
